(19) United States
(12) Patent Application Publication
(10) Pub. No.: US 2024/0059567 A1
(43) Pub. Date: Feb. 22, 2024

(54) METHOD OF MAKING A CATHODE ACTIVE MATERIAL HAVING AN OLIVINE STRUCTURE

(71) Applicant: Redwood Materials, Carson City, NV (US)

(72) Inventors: Yu-Hua Kao, Carson City, NV (US); Alan Nelson, Carson City, NV (US)

(21) Appl. No.: 18/225,726

(22) Filed: Jul. 25, 2023

Related U.S. Application Data
(60) Provisional application No. 63/399,879, filed on Aug. 22, 2022.

(51) Int. Cl. C01B 25/30

(52) U.S. Cl. CPC C01B 25/30; C01P 2006/40; C01P 2006/80

(57) ABSTRACT

A method of making a cathode active material includes providing a first mixture including a mixed metal composition and phosphoric acid or a mixed metal composition and water. The mixed metal composition includes nickel, cobalt, manganese, or a combination thereof. A salt of iron, manganese, cobalt, or a combination thereof is added to adjust the stoichiometry of the mixed metal composition. The stoichiometrically-adjusted mixed metal composition in water can be contacted with a phosphorus-containing compound. The stoichiometrically-adjusted mixed metal phosphate is further contacted with a lithium-containing compound to provide the cathode active material having at least one phase having an olivine structure.

### CROSS REFERENCE TO RELATED APPLICATION

This application claims priority to U.S. Provisional Patent Application No. 63/399,879, filed on Aug. 22, 2022 in the United States Patent and Trademark Office, and all the benefits accruing therefrom under 35 U.S.C. § 119, the contents of which are incorporated by reference herein in their entirety.

### BACKGROUND

Lithium-ion batteries have become a popular power source in various applications including consumer electronics and electric vehicles. Millions of cells have been produced. Nonetheless, there remains a continuing need for improved methods of recovering and repurposing spent batteries. It would be particularly advantageous to provide a method for preparing cathode active materials having a particular structure for new batteries from other than new feedstock.

### SUMMARY

In an aspect, a method of making a cathode active material comprises contacting a mixed metal composition with an acidic solution comprising phosphoric acid to form a first solution, the mixed metal composition comprising nickel, cobalt, manganese, or a combination thereof; and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, cobalt, or a combination thereof to the first solution to provide a second solution, combining the second solution and an alkaline lithium-containing solution to form a cathode active material, wherein the cathode active material comprises at least one phase having an olivine structure.

In an aspect, a method of making a cathode active material comprises contacting a mixed metal composition with an acidic solution comprising phosphoric acid to form a first solution, the mixed metal composition comprising manganese, and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first solution to provide a second solution; combining the second solution and an alkaline lithium-containing solution to form a cathode active material; wherein the cathode active material comprises at least one phase having an olivine structure.

In an aspect, a method of making a cathode active material comprises contacting a mixed metal composition with water to form a first mixture, the mixed metal composition comprising nickel, cobalt, manganese, or a combination thereof; and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first mixture to provide a second mixture, combining the second mixture and a phosphate-containing compound to provide a third mixture, combining the third mixture with a lithium-containing compound and a carbon-containing compound to provide a cathode active material precursor, and heat-treating the cathode active material precursor under conditions effective to provide the cathode active material, wherein the cathode active material comprises at least one phase having an olivine structure.

In an aspect, a method of making a cathode active material comprises contacting a mixed metal composition with water to form a first mixture, the mixed metal composition comprising manganese; and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first mixture to provide a second mixture, combining the second mixture and a phosphate-containing compound to provide a third mixture, combining the third mixture with a lithium-containing compound and a carbon-containing compound to provide a cathode active material precursor, and heat-treating the cathode active material precursor under conditions effective to provide the cathode active material, wherein the cathode active material comprises at least one phase having an olivine structure.

In an aspect, a cathode active material comprises a first phase having a formula of Li₁₋ₓM_{y}Fe_{1-y}PO₄ and having an olivine structure; and a second phase; wherein M is Ni, Co, Mn, or a combination thereof; 0<x≤0.5; 0<y≤1; 0.95<(M+Fe):P<1.1; 1.0<Li:(M+Fe)<1.05; 0.95<Li:P<1.05; and the second phase is derived from a recycled feedstock.

In an aspect, a cathode active material comprises a first phase having a formula of Li₁₋ₓM_{y}Fe_{1-y}PO₄ and having an olivine structure, wherein M is Ni, Co, Mn, or a combination thereof; 0<x≤0.5; 0<y≤1; 0.95<(M+Fe):P<1.1; 1.0<Li:(M+Fe)<1.05; 0.95<Li:P<1.05; and wherein the first phase further comprises Al, Cu, Fe, Mg, Na, Ca, Zn, F, Si, Li, or a combination thereof.

The above described and other features are exemplified by the following detailed description.

### DETAILED DESCRIPTION

The present inventors have discovered a method for re-manufacturing batteries and battery materials, particularly cathode active materials and the precursors thereof, wherein the cathode active materials have at least one phase having an olivine structure. Cathode active materials prepared according to the methods described herein are expected to exhibit comparable or improved battery performance, despite utilizing high percentages of feedstock derived from exhausted batteries or battery manufacturing scrap.

Accordingly, an aspect of the present disclosure is a method of making a cathode active material from a mixed metal composition. In an aspect, the mixed metal composition comprises a mixed metal sulfate, a mixed metal nitrate, a mixed metal acetate, a mixed metal hydroxide, or a combination thereof. In a specific aspect, the mixed metal composition comprises a mixed metal sulfate.

In an aspect, the mixed metal composition comprises nickel, cobalt, manganese, or a combination thereof. For example, the mixed metal composition can preferably comprise nickel, cobalt, and manganese. In an aspect, the mixed metal composition can comprise manganese. The mixed metal composition may further include greater than 0 to 2 weight percent, based on the total weight of the mixed metal composition, of a compound comprising Al, Cu, Fe, Mg, Na, Ca, Zn, F, Si, Li, or a combination thereof. For example, the mixed metal composition can comprise greater than 0 to 1.5 weight percent, or greater than 0.0001 to 1 weight percent, or greater than 0.001 to 0.5 weight percent, or greater than 0 to 0.1 weight percent, or greater than 0 to 0.01 weight percent (100 ppm) of the compound comprising Al, Cu, Fe, Mg, Na, Ca, Zn, F, Si, Li, or a combination thereof, based on a total weight of the mixed metal composition. In an aspect, the mixed metal composition can comprise greater than 0 to 1000 ppm, or greater than 0 to 750 ppm, or 5 to 750 ppm, or 5 to 1000 ppm, or 25 to 1000 ppm, or 25 to 750 ppm, or 50 to 750 ppm, or 100 to 750 ppm of the compound comprising Al, Cu, Fe, Mg, Na, Ca, Zn, F, Si, Li, or a combination thereof, based on a total weight of the mixed metal composition. For example, the mixed metal composition can comprise one or more of 0.5 to 1.5 weight percent Co, 50 to 300 ppm Cu, 50 to 200 ppm of Al, 5 to 100 ppm of Fe, or 5 to 100 ppm of F, each based on the total weight of the mixed metal composition. In an aspect, the mixed metal composition can comprise lithium. When present, lithium can preferably be present in the mixed metal composition in an amount of 100 to 1000 ppm, based on the total weight of the mixed metal composition.

In an aspect, the mixed metal composition comprises nickel, cobalt, and manganese (e.g., wherein nickel, cobalt, and manganese are present as major constituents in the mixed metal composition). For example, nickel, cobalt, and manganese may be present in the mixed metal composition in an amount of at least 5 weight percent, or at least 10 weight percent, or at least 15 weight percent, or at least 18 weight percent, based on a total weight of the mixed metal composition. In an aspect, nickel, cobalt, and manganese may be present in the mixed metal composition in an amount of 5 to 98 weight percent, or 5 to 85 weight percent, or 5 to 75 weight percent, or 5 to 50 weight percent, or 15 to 25 weight percent, based on a total weight of the mixed metal composition. The mixed metal composition may further include greater than 0 to 2 weight percent, based on the total weight of the mixed metal composition, of a compound comprising Al, Cu, Fe, Mg, Na, Ca, Zn, F, Si, Li, or a combination thereof. For example, the mixed metal composition can comprise greater than 0 to 1.5 weight percent, or greater than 0.0001 to 1 weight percent, or greater than 0.001 to 0.5 weight percent, or greater than 0 to 0.1 weight percent, or greater than 0 to 0.01 weight percent (100 ppm) of the compound comprising Al, Cu, Fe, Mg, Na, Ca, Zn, F, Si, Li, or a combination thereof, based on a total weight of the mixed metal composition. In an aspect, the mixed metal composition can comprise greater than 0 to 1000 ppm, or greater than 0 to 750 ppm, or 5 to 750 ppm, or 5 to 1000 ppm, or 25 to 1000 ppm, or 25 to 750 ppm, or 50 to 750 ppm, or 100 to 750 ppm of the compound comprising Al, Cu, Fe, Mg, Na, Ca, Zn, F, Si, Li, or a combination thereof, based on a total weight of the mixed metal composition. For example, the mixed metal composition can comprise 0.5 to 1.5 weight percent Co, 50 to 300 ppm Cu, 50 to 200 ppm of Al, 5 to 100 ppm of Fe, or 5 to 100 ppm of F, each based on the total weight of the mixed metal composition. In an aspect, the mixed metal composition can comprise lithium. When present, lithium can preferably be present in the mixed metal composition in an amount of 100 to 1000 ppm, based on the total weight of the mixed metal composition.

In an aspect, the mixed metal composition comprises manganese (e.g., wherein manganese is present as a major constituent in the mixed metal composition). For example, manganese may be present in the mixed metal composition in an amount of at least 5 weight percent, or at least 10 weight percent, or at least 15 weight percent, or at least 18 weight percent, based on a total weight of the mixed metal composition. In an aspect, manganese may be present in the mixed metal composition in an amount of 5 to 98 weight percent, or 5 to 85 weight percent, or 5 to 75 weight percent, or 5 to 50 weight percent, or 15 to 25 weight percent, based on a total weight of the mixed metal composition. The mixed metal composition may further include greater than 0 to 2 weight percent, based on the total weight of the mixed metal composition, of a compound comprising Al, Cu, Fe, Mg, Na, Ca, Zn, F, Si, Li, or a combination thereof. For example, the mixed metal composition can comprise greater than 0 to 1.5 weight percent, or greater than 0.0001 to 1 weight percent, or greater than 0.001 to 0.5 weight percent, or greater than 0 to 0.1 weight percent, or greater than 0 to 0.01 weight percent (100 ppm) of the compound comprising Al, Cu, Fe, Mg, Na, Ca, Zn, F, Si, Li, or a combination thereof, based on a total weight of the mixed metal composition. In an aspect, the mixed metal composition can comprise greater than 0 to 1000 ppm, or greater than 0 to 750 ppm, or 5 to 750 ppm, or 5 to 1000 ppm, or 25 to 1000 ppm, or 25 to 750 ppm, or 50 to 750 ppm, or 100 to 750 ppm of the compound comprising Al, Cu, Fe, Mg, Na, Ca, Zn, F, Si, Li, or a combination thereof, based on a total weight of the mixed metal composition. For example, the mixed metal composition can comprise 0.5 to 1.5 weight percent Co, 50 to 300 ppm Cu, 50 to 200 ppm of Al, 5 to 100 ppm of Fe, or 5 to 100 ppm of F, each based on the total weight of the mixed metal composition. In an aspect, the mixed metal composition can comprise lithium. When present, lithium can preferably be present in the mixed metal composition in an amount of 100 to 1000 ppm, based on the total weight of the mixed metal composition.

In an aspect, the mixed metal composition can comprise nickel and greater than 0 to 2 weight percent, based on the total weight of the mixed metal composition, of Co, Al, Cu, Fe, Mg, F, Si, or a combination thereof. In an aspect, the mixed metal composition can comprise nickel and manganese and greater than 0 to 2 weight percent, based on the total weight of the mixed metal composition, of Co, Al, Cu, Fe, Mg, F, Si, or a combination thereof. In an aspect, the mixed metal composition can comprise manganese and greater than 0 to 2 weight percent, based on the total weight of the mixed metal composition, of Co, Al, Cu, Fe, Mg, F, Si, or a combination thereof.

The mixed metal composition can be obtained, for example, from exhausted lithium-ion batteries, lithium-ion battery production waste, and the like, or a combination thereof. For example, the mixed metal composition can be obtained from a recycled feedstock, preferably a post-industrial recycled feedstock, a post-consumer recycled feedstock, or a combination thereof. In an aspect, the Al, Cu, Fe, Mg, Na, Ca, Zn, F, Si, Li, or a combination thereof of the compound comprising Al, Cu, Fe, Mg, Na, Ca, Zn, F, Si, Li, or a combination thereof arises from a recycled feedstock, e.g., an exhausted battery or battery manufacturing scrap. The exhausted lithium-ion batteries (or any of the foregoing lithium-ion battery component sources) can be crushed, granulated, shredded, or the like, and subjected to a physical separation process to separate solid battery components (e.g., casings, electrodes, tabs, headers, fuses, and the like) from volatile components, e.g., electrolyte solvents. Electrolyte salts (e.g., LiPF₆) can be removed by soaking in a suitable solvent (e.g., propylene carbonate), and the remaining undissolved materials (e.g., electrode materials, current collector) can be isolated, for example by filtration. Electrode particles can be separated from residual current collector materials, for example by contacting with a solvent suitable to dissolve the electrode particles or release them by dissolving a binder, facilitating removal of the solid metal conductor components. The isolated electrode particles can be contacted with a leaching solution to extract elements such as Ni, Co, Mn, Al, Li, and Fe. Exemplary leaching solutions can include, but are not limited to, sulfuric acid (e.g., 2 to 5 molar (M) sulfuric acid), optionally including hydrogen peroxide. The resulting solution can be centrifuged or filtered to remove any particulates and subjected to conditions effective to induce crystallization or precipitation of the desired mixed metal composition. For example, the filtered solution can be concentrated (e.g., in an evaporator) at 75 to 85° C., or 78 to 82° C., or 80° C. The concentrated solution can be cooled, e.g., to a temperature of less than 20° C., or 10 to 18° C., or 15° C. to crystallize the mixed metal composition.

The precipitated or recrystallized mixed metal composition can be isolated, for example using filtration, centrifugation, or the like, or a combination thereof. In an aspect, the mixed metal composition can be dewatered to a moisture content of 10% or less, for example 1 to 10%, or 5 to 10%, based on a total weight of the mixed metal composition product.

The mixed metal composition can be soluble in an aqueous solution having a pH of 5 or less, for example, greater than 0 to 5 or less, or 1 to 5, or 2 to 5, or 3 to 5, or 1 to 4, or 1 to 3, or 2 to 3.

In an aspect, the mixed metal composition may be contacted with an acidic solution to form a first solution. The acidic solution comprises phosphoric acid. In an aspect, the acidic solution can comprise phosphoric acid and one or more of oxalic acid, acetic acid, and nitric acid. The first solution can have a pH of 5 or less, for example, greater than 0 to 5 or less, or 1 to 5, or 2 to 5, or 3 to 5, or 1 to 4, or 1 to 3, or 2 to 3.

The method further comprises adding a salt of nickel, iron, manganese, cobalt, or a combination thereof to the first solution to provide a second solution. In an aspect, the foregoing salts can be virgin materials (i.e., not recovered or recycled from exhausted lithium-ion batteries, or otherwise previously used). In an aspect, the salt of iron, manganese, cobalt, or a combination thereof is a sulfate or a hydroxide thereof (e.g., iron sulfate, manganese sulfate, cobalt sulfate, iron hydroxide, manganese hydroxide, cobalt hydroxide, or a combination thereof). In an aspect, the salt comprises FeSO₄, MnSO₄, CoSO₄, or a combination thereof. Use of a hydrate of FeSO₄, MnSO₄, CoSO₄ is mentioned.

The salt can be added in an amount effective to achieve a desired stoichiometry of nickel, cobalt, manganese, and iron. For example, the salt of nickel, iron, manganese, cobalt, or the combination thereof can be added to the first solution in an amount effective to provide a molar ratio of Ni:Co:Mn:Fe of greater than 0 to 0.5:greater than 0 to 0.5:greater than 0 to 1:greater than 0 to 1, preferably 0.05:0.05:0.4:0.5.

The mixed metal composition of the first solution (e.g., recovered or recycled from exhausted lithium-ion batteries or manufacturing scrap) can be contacted with the virgin salts in a suitable amount to provide the stoichiometrically-adjusted mixed metal composition. In an aspect, the mixed metal composition (i.e., of the first solution) can account for 10 to 95 weight percent of the stoichiometrically-adjusted mixed metal composition of the second solution. Within this range, the mixed metal composition can account for 15 to 95 weight percent, or 20 to 95 weight percent, or 25 to 95 weight percent, or 30 to 90 weight percent of the stoichiometrically-adjusted mixed metal composition, based on a total weight of the second solution.

The second solution can have a pH that is the same or different from the pH of the first solution. In an aspect, the pH of the second solution can be less than 7, or less than 6.5, for example greater than 0 to less than 7, or 1 to less than 7, or 1 to less than 6.5 or 1 to 6, or 2 to 6, or 2 to 5. As described above, the salt is added to achieve a desired stoichiometry of nickel, cobalt, manganese, iron, or combination thereof of the mixed metal composition of the second solution.

In addition to the stoichiometrically-adjusted mixed metal composition, the second solution can further comprise 0.0001 to 2 weight percent, based on the total weight of the stoichiometrically-adjusted mixed metal composition, of Al, Cu, Fe, Mg, Na, Ca, Zn, F, Li, or a combination thereof or 0.0001 to 2 weight percent, based on the total weight of the stoichiometrically-adjusted mixed metal composition, of Al, Cu, Fe, Mg, Na, Ca, Zn, F, Li, or a combination thereof. Stated another way, the foregoing additional components of the mixed metal composition (e.g., Al, Cu, Fe, Mg, Na, Ca, Zn, F, Li, or a combination thereof) have not been removed, and thus remain present in the second solution. In an aspect, these components are not added to the either the first solution or the second solution. Rather, in an aspect, these components are present at the outset of the method, arising from the mixed metal feedstock, e.g., from the recycled batteries or battery scrap, used in the method of the present disclosure.

The method further comprises combining the second solution and an alkaline lithium-containing solution to form a cathode active material. The alkaline lithium-containing solution can comprise, for example, a lithium hydroxide, lithium carbonate, lithium bicarbonate, or a combination thereof. In an aspect, the alkaline lithium-containing solution can comprise lithium hydroxide. The alkaline lithium-containing solution can be combined with the second solution in an amount such that the resulting solution has a pH of greater than 7, preferably 7 to 10, or 7 to 9, or 7 to 8.

Combining the second solution and the alkaline lithium-containing solution can provide the cathode active material as a precipitate. Combination of the alkaline lithium-containing solution and the second solution can optionally be with agitation, for example at a speed of 500-1500 RPM, and at a temperature of 25 to 90° C.

The method can further include isolating the precipitated cathode active material. Isolation can be using any suitable liquid-solid separation technique, including, for example, filtration, centrifugation, and the like, or a combination thereof. The precipitate can be washed (e.g., with deionized water, distilled water, and the like, or a combination thereof) and dried (e.g., at a temperature of 80 to 100° C., for example 85 to 95° C., under nitrogen).

In an aspect, the isolated cathode active material can be further combined with a conductive carbon material. For example, the cathode active material can optionally be combined with conductive carbon black. In an aspect, the carbon black can have a BET surface area of less than 100 m²/g and an oil adsorption number (OAN) of greater than 100 milliliters per 100 grams. An example of a commercially available carbon black suitable for use in the present disclosure is LITX-HP, available from Cabot Corporation.

Alternatively, in an aspect, the mixed metal composition may be contacted with water to form a first mixture. The first mixture may be in the form of a slurry. In an aspect, the first mixture can have a solids content of 10 weight percent or more. The mixed metal composition may be as described above. For example, in an aspect, the mixed metal composition may comprise nickel, cobalt, manganese, or a combination thereof and greater than 0 to 2 weight percent, based on the total weight of the mixed metal composition, of a compound comprising Al, Cu, Fe, Mg, Na, Ca, Zn, F, Si, Li, or a combination thereof. In an aspect, the mixed metal composition may comprise manganese, and greater than 0 to 2 weight percent, based on the total weight of the mixed metal composition, of a compound comprising Al, Cu, Fe, Mg, Na, Ca, Zn, F, Si, Li, or a combination thereof.

The method further comprises adding a salt of iron, manganese, or a combination thereof to the first mixture to provide a second mixture. In an aspect, the foregoing salts can be virgin materials (i.e., not recovered or recycled from exhausted lithium-ion batteries, or otherwise previously used). In an aspect, the salt of iron, manganese, or a combination thereof is a sulfate or a hydroxide thereof (e.g., iron sulfate, manganese sulfate, iron hydroxide, manganese hydroxide, or a combination thereof). In an aspect, the salt comprises FeSO₄, MnSO₄, or a combination thereof. Use of a hydrate of FeSO₄ and MnSO₄ is mentioned.

The salt can be added in an amount effective to achieve a desired stoichiometry of nickel, manganese, and iron.

The mixed metal composition of the first mixture (e.g., recovered or recycled from exhausted lithium-ion batteries or manufacturing scrap) can be contacted with the virgin salts in a suitable amount to provide the stoichiometrically-adjusted mixed metal composition. In an aspect, the mixed metal composition (i.e., of the first solution) can account for 10 to 95 weight percent of the stoichiometrically-adjusted mixed metal composition of the second mixture. Within this range, the mixed metal composition can account for 15 to 95 weight percent, or 20 to 95 weight percent, or 25 to 95 weight percent, or 30 to 90 weight percent of the stoichiometrically-adjusted mixed metal composition, based on a total weight of the second mixture.

In addition to the stoichiometrically-adjusted mixed metal composition, the second mixture can further comprise 0.0001 to 2 weight percent, based on the total weight of the stoichiometrically-adjusted mixed metal composition, of Al, Cu, Fe, Mg, Na, Ca, Zn, F, Li, or a combination thereof or 0.0001 to 2 weight percent, based on the total weight of the stoichiometrically-adjusted mixed metal composition, of Al, Cu, Fe, Mg, Na, Ca, Zn, F, Li, or a combination thereof. Stated another way, the foregoing additional components of the mixed metal composition (e.g., Al, Cu, Fe, Mg, Na, Ca, Zn, F, Li, or a combination thereof) have not been removed, and thus remain present in the second mixture. In an aspect, these components are not added to the either the first mixture or the second mixture. Rather, in an aspect, these components are present at the outset of the method, arising from the mixed metal feedstock, e.g., from the recycled batteries or battery scrap, used in the method of the present disclosure.

The method further comprises combining the second mixture and a phosphate-containing compound to provide a third mixture. The phosphate-containing compound can comprise a phosphate, for example, phosphoric acid, dibasic phosphate, monobasic phosphates, or a combination thereof. In an aspect, the phosphate-containing compound comprises phosphoric acid.

In addition to the stoichiometrically-adjusted mixed metal composition and the phosphate-containing compound, the third mixture can further comprise 0.0001 to 2 weight percent, based on the total weight of the stoichiometrically-adjusted mixed metal composition, of Al, Cu, Fe, Mg, Na, Ca, Zn, F, Li, or a combination thereof or 0.0001 to 2 weight percent, based on the total weight of the stoichiometrically-adjusted mixed metal composition, of Al, Cu, Fe, Mg, Na, Ca, Zn, F, Li, or a combination thereof. Stated another way, the foregoing additional components of the mixed metal composition (e.g., Al, Cu, Fe, Mg, Na, Ca, Zn, F, Li, or a combination thereof) have not been removed, and thus remain present in the third mixture. In an aspect, these components are not added to any of the first, second, or third mixtures. Rather, in an aspect, these components are present at the outset of the method, arising from the mixed metal feedstock, e.g., from the recycled batteries or battery scrap, used in the method of the present disclosure.

The method further comprises combining the third mixture with a lithium-containing compound and a carbon-containing compound to provide a cathode active material precursor and heat-treating the cathode active material precursor under conditions effective to provide the cathode active material comprising at least one phase having an olivine structure. Exemplary lithium compounds can include lithium hydroxide, lithium carbonate, lithium oxide, lithium oxalate, or a combination thereof. In an aspect, the lithium compound can comprise lithium hydroxide.

The carbon-containing compound can be a conductive carbon compound, for example carbon black. In an aspect, the carbon black can have a BET surface area of less than 100 m²/g and an oil adsorption number (OAN) of greater than 100 milliliters per 100 grams. An example of a commercially available carbon black suitable for use in the present disclosure is LITX-HP, available from Cabot Corporation. In an aspect, the carbon-containing compound can comprise a carbohydrate, for example glucose, sucrose, or the like, or a combination thereof. The carbon-containing compounds are preferably conductive or can be made conductive after heat treatment.

Heat-treating the mixture can comprise calcining at a temperature of 550 to 950° C. for 4 to 48 hours in the presence of inert atmosphere (e.g., nitrogen, argon).

In an aspect, the method may further comprise reducing the particle size of the third mixture prior to heat treating. Reduction in particle size can be accomplished using any known mechanical grinding methods, such as by wet milling. The slurry can be wet milled to provide a final D50 particle size of, for example, 100 to 500 nanometers.

Accordingly, the cathode active material can comprise Li, Fe, and a metal comprising Ni, Co, Mn, or a combination thereof. The Li and total content of Ni, Co, Mn and Fe can be present in a Li:(Ni, Co, Mn and Fe) ratio of 1:1 to 1.05:1. The cathode active material comprises phosphorus in a (Ni, Co, Mn and Fe):phosphorus ratio of 0.95:1 to 1.1:1. The lithium and the phosphorus can be present in a Li:P ratio of 0.95 to 1.05.

For example, the cathode active material can comprise a compound according to the Formula Li₁₋ₓM_{y}Fe_{1-y}PO₄ wherein M is Ni, Co, Mn, or a combination thereof, 0<x≤0.5; 0<y≤1; 0.95<(M+Fe):P<1.1; 1.0<Li:(M+Fe)<1.05; 0.95<Li:P<1.05, and wherein the compound according to the Formula Li₁₋ₓM_{y}Fe_{1-y}PO₄ has an olivine structure. The olivine structure can be confirmed, for example, using X-ray diffraction techniques (XRD).

The cathode active material prepared by the method disclosed herein comprises at least one phase having an olivine structure. “Olivine structure” as would be understood by an artisan in the solid-state sciences and as is used herein means that the compound is isostructural with olivine, i.e., MgFeSiO₄. The olivine structure can refer to a phase having an orthorhombic crystal structure and a space group of Pbnm. The olivine structure of the cathode active material can be characterized using, for example, X-ray diffraction (XRD).

A cathode active material prepared according to the methods described herein represents another aspect of the present disclosure.

For example, in an aspect, a cathode active material can comprise a first phase having a formula of Li₁₋ₓ M_{y}Fe_{1-y}PO₄ and having an olivine structure, and a second phase, wherein M is Ni, Co, Mn, or a combination thereof; 0<x≤0.5; 0<y≤1; 0.95<(M+Fe):P<1.1; 1.0<Li:(M+Fe)<1.05; 0.95<Li:P<1.05; and the second phase is derived from a recycled feedstock. For example, the second phase can comprise a compound comprising one or more of Al, Cu, Fe, Mg, Na, Ca, Zn, F, Si, or Li, or a combination thereof. In an aspect, the second phase derived from the recycled feedstock is present in an amount of 0.01 to 10 weight percent (wt %), 0.1 to 5 wt %, or 0.2 to 2 wt %, based on the total weight of the cathode active material. In an aspect, the Al, Cu, Fe, Mg, Na, Ca, Zn, F, Si, or Li, or a combination thereof can be derived from a recycled feedstock.

In an aspect, a cathode active material can comprise a first phase having a formula of Li₁₋ₓM_{y}Fe_{1-y}PO₄ and having an olivine structure, wherein M is Ni, Co, Mn, or a combination thereof; 0<x≤0.5; <y≤1; 0.95<(M+Fe):P<1.1; 1.0<Li:(M+Fe)<1.05; 0.95<Li:P<1.05; and wherein the first phase further comprises Al, Cu, Fe, Mg, Na, Ca, Zn, F, Si, Li, or a combination thereof.

In an aspect, the cathode active material can be used in combination with a virgin cathode active material (i.e., one which has not been prepared using a recycled feedstock). For example, a cathode active material can comprise a first cathode active material comprising the first phase of the formula Li₁₋ₓM_{y}Fe_{1-y}PO₄ and having an olivine structure; and the second phase derived from recycled feedstock; and a second cathode active material comprising a cathode active material derived from virgin feedstock. In an aspect, a cathode active material can comprise a first cathode active material comprising the first phase and further comprising Al, Cu, Fe, Mg, Na, Ca, Zn, F, Si, Li, or a combination thereof; and a second cathode active material comprising a cathode active material derived from virgin feedstock. The cathode active material of the present disclosure and a virgin cathode active material can be combined in a weight ratio of 1:99 to 99:1, or 10:90 to 90:10, or 20:80 to 80:20, or 30:70 to 70:30, or 40:60 to 60:40, or 45:55 to 55:45, or 50:50.

The cathode active material disclosed herein can exhibit one or more advantageous properties. For example, the cathode active material can have a discharge capacity of greater than 100 mAh/g (e.g., 150 mAh/g) at a discharge rate of C/20 for a half-cell over 100 cycles at 20° C. when using a lithium anode and an electrolyte comprising 1 M LiPF₆ in a 1:1 by volume ethylene carbonate:dimethyl carbonate. In an aspect, the cathode active material can have a discharge capacity of 120 mAh/g at a rate of 5 C or a discharge capacity of 100 mAh/g at a rate of 10 C over 100 cycles. The C rate refers to a current which will discharge the cell in one hour, thus 10 C refers to a current which will discharge the cell in 6 minutes.

The cathode active material described herein can be particularly useful in a battery cathode. A battery cathode can therefore comprise a cathode active material made by the method described herein, optionally in combination with a virgin cathode active material (i.e., one which has not been prepared using a recycled feedstock).

This disclosure is further illustrated by the following examples, which are non-limiting.

### EXAMPLES

### Comparative Example 1

Commercial battery grade metal sulfates (NiSO₄, CoSO₄, MnSO₄, FeSO₄) are dissolved in 0.5 molar (M) phosphoric acid (H₃PO₄) with a stoichiometric ratio of Ni:Co:Mn:Fe of 0.1:0.1:0.3:0.5 and a total content of (Ni+Co+Mn+Fe):phosphorus ratio of 1:1. Lithium hydroxide solution is added dropwise over 30 minutes, and the solution temperature is maintained at 100° C. or at the boiling point of the solution. The lithium:phosphorus ratio is 3:1. Solid precipitates are separated from the solution and dried under nitrogen. Analysis by X-ray Diffraction (XRD) will show an olivine crystal structure is obtained.

### Example 1

Mixed metal sulfates prepared from a recycled stream are dissolved in phosphoric acid. The stoichiometric ratio of Ni:Co:Mn:Fe is adjusted to 0.1:0.1:0.4:0.5 by addition of battery grade metal sulfates. The total content of (Ni+Co+Mn+Fe):phosphorus ratio is 1:1. Lithium hydroxide solution is added dropwise over 30 minutes, and the solution temperature is maintained at 100° C. or at the boiling point of the solution. The lithium:phosphorus ratio is 3:1. Solid precipitates are separated from the solution and dried under nitrogen. Analysis by X-ray Diffraction (XRD) will show an olivine crystal structure is obtained.

### Example 2

The materials prepared in Comparative Example 1 and Example 1 are mixed with conductive carbon black (e.g., LITX-HP obtained from Cabot Corporation) at a weight ratio of 95:5 by ball milling to provide carbon-modified cathode active materials.

### Comparative Example 2

Commercial battery grade Ni(OH)₂, Co(OH)₂, MnCO₃, FeC₂O₄ are added to water with a stoichiometric ratio of Ni:Co:Mn:Fe of 0.05:0.05:0.4:0.5 and at a solids content of 10 weight precent. Phosphoric acid is added to the slurry. The total content of (Ni+Co+Mn+Fe):phosphorus ratio is 1:1. Lithium hydroxide solution is added dropwise over 30 minutes in an amount to provide a Li:P ratio of 1:1. Glucose (2.5 weight percent) and sucrose (2.5 weight percent) are added to the slurry and mixed for an additional 30 minutes. The resulting slurry is milled to provide a final D50 particle size of less than 150 nanometers.

### Example 3

Mixed metal hydroxides (Ni, Co, Mn hydroxide) made from a recycled stream are used as raw materials to synthesize olivine type cathode active materials. The mixed metal hydroxide composition is stoichiometrically adjusted to provide a ratio of Ni:Co:Mn:Fe of 0.05:0.05:0.4:0.5 with MnCO₃ and FeC₂O₄ and water to provide a slurry having a 10% solid loading. Phosphoric acid is added to the slurry. The total metal (Ni+Co+Mn+Fe):phosphorus ratio is 1:1. Lithium hydroxide solution is added dropwise over 30 minutes in an amount to provide a Li:P ratio of 1:1. Glucose (2.5 weight percent) and sucrose (2.5 weight percent) are added to the slurry and mixed for an additional 30 minutes. The resulting slurry is milled to provide a final D50 particle size of less than 150 nanometers.

### Example 4

The milled slurry of Comparative Example 2 and Example 3 are further dried using conventional drying methods, including pan drying, spray drying, or the like. The dried solid is then heat treated at 650° C. under nitrogen to provide the desired cathode active material. Analysis by X-ray Diffraction (XRD) will show an olivine crystal structure is obtained.

This disclosure further encompasses the following aspects.

Aspect 1: A method of making a cathode active material, the method comprising: contacting a mixed metal composition with an acidic solution comprising phosphoric acid to form a first solution, the mixed metal composition comprising nickel, cobalt, manganese, or a combination thereof; and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, cobalt, or a combination thereof to the first solution to provide a second solution, combining the second solution and an alkaline lithium-containing solution to form a cathode active material, wherein the cathode active material comprises at least one phase having an olivine structure.

Aspect 2: A method of making a cathode active material, the method comprising: contacting a mixed metal composition with an acidic solution comprising phosphoric acid to form a first solution, the mixed metal composition comprising manganese, and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first solution to provide a second solution; combining the second solution and an alkaline lithium-containing solution to form a cathode active material; wherein the cathode active material comprises at least one phase having an olivine structure.

Aspect 3: The method of aspect 1 or 2, further comprising combining the cathode active material with a conductive carbon, preferably conductive carbon black.

Aspect 4: The method of any of aspects 1 or 2 to 3, wherein the mixed metal composition is obtained by a method comprising contacting electrode particles comprising nickel, cobalt, manganese, or a combination thereof; and greater than 0 to 2 weight percent, based on the total weight of the mixed metal composition, of a compound comprising Al, Cu, Fe, Mg, Na, Ca, Zn, F, Si, Li, or a combination thereof; with a leaching solution, preferably comprising sulfuric acid; precipitating the mixed metal composition from the leaching solution; and isolating the mixed metal composition from the leaching solution.

Aspect 5: The method of any of aspects 2 to 3, wherein the mixed metal composition is obtained by a method comprising contacting electrode particles comprising manganese, and greater than 0 to 2 weight percent, based on the total weight of the mixed metal composition, of a compound comprising Al, Cu, Fe, Mg, Na, Ca, Zn, F, Si, Li, or a combination thereof; with a leaching solution, preferably comprising sulfuric acid; precipitating the mixed metal composition from the leaching solution; and isolating the mixed metal composition from the leaching solution.

Aspect 6: The method of any of aspects 1 to 5, wherein the mixed metal composition is soluble in an aqueous solution having a pH of 5 or less.

Aspect 7: The method of any of aspects 1 to 6, wherein the mixed metal composition comprises a mixed metal sulfate, a mixed metal nitrate, a mixed metal acetate, a mixed metal hydroxide, or a combination thereof.

Aspect 8: The method of any of aspects 1 to 7, wherein the mixed metal composition comprises a mixed metal sulfate.

Aspect 9: The method of any of aspects 1 to 8, wherein the acidic solution comprises phosphoric acid and one or more of oxalic acid, acetic acid, or nitric acid.

Aspect 10: The method of any of aspects 1 to 9, wherein the mixed metal composition further comprises lithium, preferably in an amount of 100 to 1000 ppm, based on the total weight of the mixed metal composition.

Aspect 11: The method of any of aspects 1 to 10, wherein the mixed metal composition is obtained from a recycled feedstock, preferably a post-industrial recycled feedstock, a post-consumer recycled feedstock, or a combination thereof.

Aspect 12: The method of any of aspects 1 to 11, wherein the mixed metal composition comprises 0.5 to 1.5 weight percent Co, 50 to 300 ppm Cu, 50 to 200 ppm of Al, 5 to 100 ppm of Fe, or 5 to 100 ppm of F, each based on the total weight of the mixed metal composition.

Aspect 13: The method of any of aspects 1 to 12, wherein the first solution has a pH of less than 5.

Aspect 14: The method of any of aspects 1 to 13, wherein the salt of iron, manganese, cobalt, or a combination thereof is a sulfate or a hydroxide thereof.

Aspect 15: The method of any of aspects 1 to 14, wherein adding the salt of iron, manganese, cobalt, or a combination thereof to the first solution in an amount effective to provide a molar ratio of Ni:Co:Mn:Fe of greater than 0 to 0.5:greater than 0 to 0.5:greater than 0 to 1:greater than 0 to 1, preferably 0.05:0.05:0.4:0.5.

Aspect 16: The method of any of aspects 1 to 15, wherein the second solution comprises of 0.0001 to 2 weight percent, based on the total weight of the solution, of Al, Cu, Fe, Mg, Na, Ca, Zn, F, Li, or a combination thereof.

Aspect 17: The method of any of aspects 1 to 21, wherein the alkaline lithium-containing solution comprises a lithium hydroxide, lithium carbonate, lithium bicarbonate, or a combination thereof, preferably lithium hydroxide.

Aspect 18: The method of aspect 17, wherein the alkaline lithium-containing solution is combined with the second solution in an amount effective to provide a pH of greater than 7, preferably 7 to 10, or 7 to 9, or 7 to 8.

Aspect 19: The method of any of aspects 1 to 18, further comprising isolating the cathode active material.

Aspect 20: A method of making a cathode active material, the method comprising: contacting a mixed metal composition with water to form a first mixture, the mixed metal composition comprising nickel, cobalt, manganese, or a combination thereof; and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first mixture to provide a second mixture, combining the second mixture and a phosphate-containing compound to provide a third mixture, combining the third mixture with a lithium-containing compound and a carbon-containing compound to provide a cathode active material precursor, and heat-treating the cathode active material precursor under conditions effective to provide the cathode active material, wherein the cathode active material comprises at least one phase having an olivine structure.

Aspect 21: A method of making a cathode active material, the method comprising: contacting a mixed metal composition with water to form a first mixture, the mixed metal composition comprising manganese, and greater than 0 to 2 weight percent, based on the total weight of the mixed metal composition, of a compound comprising Al, Cu, Fe, Mg, Na, Ca, Zn, F, Si, Li, or a combination thereof; adding a salt of iron, manganese, or a combination thereof to the first mixture to provide a second mixture; combining the second mixture and a phosphate-containing compound to provide a third mixture; combining the third mixture with a lithium-containing compound and a carbon-containing compound to provide a cathode active material precursor; and heat-treating the cathode active material precursor under conditions effective to provide the cathode active material, wherein the cathode active material comprises at least one phase having an olivine structure.

Aspect 22: The method of aspects 20 or 21, wherein the phosphate-containing compound comprises a phosphate comprising phosphoric acid, dibasic phosphate, a monobasic phosphate, or a combination thereof, preferably phosphoric acid.

Aspect 23: The method of any of aspects 20 to 22, wherein the first mixture is a slurry having a solids content of 10 weight percent or greater, based on a total weight of the slurry.

Aspect 24: A cathode active material made by the method of any of aspects 1 to 23.

Aspect 25: A cathode active material comprising: a first phase having a formula of Li₁₋ₓM_{y}Fe_{1-y}PO₄ and having an olivine structure; and a second phase; wherein M is Ni, Co, Mn, or a combination thereof; 0<x≤0.5; 0<y≤1; 0.95<(M+Fe):P<1.1; 1.0<Li:(M+Fe)<1.05; 0.95<Li:P<1.05; and the second phase is derived from a recycled feedstock.

Aspect 26: The cathode active material of aspect 25, wherein the second phase comprises one or more of Al, Cu, Fe, Mg, Na, Ca, Zn, F, Si, or Li.

Aspect 27: The cathode active material of any of aspects 25 to 26, wherein the second phase derived from a recycled feedstock is present in an amount of 1 to 99 weight percent, based on the total weight of the cathode active material.

Aspect 28: A cathode active material comprising: a first phase having a formula of Li₁₋ₓM_{y}Fe_{1-y}PO₄ and having an olivine structure, wherein M is Ni, Co, Mn, or a combination thereof; 0<x≤0.5; 0<y≤1; 0.95<(M+Fe):P<1.1; 1.0<Li:(M+Fe)<1.05; 0.95<Li:P<1.05; and wherein the first phase further comprises Al, Cu, Fe, Mg, Na, Ca, Zn, F, Si, Li, or a combination thereof.

Aspect 29: The cathode active material of aspect 28, wherein the Al, Cu, Fe, Mg, Na, Ca, Zn, F, Si, Li, or a combination thereof is derived from a recycled feedstock.

Aspect 30: The cathode active material of aspect 25, comprising a first cathode active material comprising the first phase; and the second phase derived from a recycled feedstock; and a second cathode active material comprising a cathode active material derived from a virgin feedstock.

Aspect 31: The cathode active material of aspect 28, comprising a first cathode active material comprising the first phase and further comprising Al, Cu, Fe, Mg, Na, Ca, Zn, F, Si, Li, or a combination thereof; and a second cathode active material comprising a cathode active material derived from the virgin feedstock.

Aspect 32: The cathode active material of aspect 30 or 31, wherein the first cathode active material and the second cathode active material are combined in a weight ratio of 1:99 to 99:1.

The compositions and methods can alternatively comprise, consist of, or consist essentially of, any appropriate materials, steps, or components herein disclosed. The compositions and methods can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

It will be further understood that the terms “comprises” and/or “comprising,” or “includes” or “including” when used in this specification, specify the presence of stated features, regions, integers, steps, operations, elements, or components, but do not preclude the presence or addition of one or more other features, regions, integers, steps, operations, elements, components, or groups thereof.

Various aspects are shown in the accompanying drawings. This invention may, however, be embodied in many different forms, and should not be construed as limited to the aspects set forth herein. Rather, these aspects are provided so that this disclosure will be thorough and complete, and will fully convey the scope of the invention to those skilled in the art. Like reference numerals refer to like elements throughout.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

U.S. Provisional Patent Application No. 63/399,879, filed on Aug. 22, 2022 is hereby incorporated by reference in its entirety for all purposes.

While a particular aspect has been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making a cathode active material, the method comprising:
contacting a mixed metal composition with an acidic solution comprising phosphoric acid to form a first solution, the mixed metal composition comprising
nickel, cobalt, manganese, or a combination thereof; and
greater than 0 to 2 weight percent, based on the total weight of the mixed metal composition, of a compound comprising Al, Cu, Fe, Mg, Na, Ca, Zn, F, Si, Li, or a combination thereof;
adding a salt of iron, manganese, cobalt, or a combination thereof to the first solution to provide a second solution,
combining the second solution and an alkaline lithium-containing solution to form a cathode active material,
wherein the cathode active material comprises at least one phase having an olivine structure.

2. A method of making a cathode active material, the method comprising:
contacting a mixed metal composition with an acidic solution comprising phosphoric acid to form a first solution, the mixed metal composition comprising
manganese, and
greater than 0 to 2 weight percent, based on the total weight of the mixed metal composition, of a compound comprising Al, Cu, Fe, Mg, Na, Ca, Zn, F, Si, Li, or a combination thereof;
adding a salt of iron, manganese, or a combination thereof to the first solution to provide a second solution;
combining the second solution and an alkaline lithium-containing solution to form a cathode active material;
wherein the cathode active material comprises at least one phase having an olivine structure.

3. The method of claim 1, further comprising combining the cathode active material with a conductive carbon, preferably conductive carbon black.

4. The method of any of claim 1, wherein the mixed metal composition is obtained by a method comprising
contacting electrode particles comprising
nickel, cobalt, manganese, or a combination thereof; and
greater than 0 to 2 weight percent, based on the total weight of the mixed metal composition, of a compound comprising Al, Cu, Fe, Mg, Na, Ca, Zn, F, Si, Li, or a combination thereof;
with a leaching solution, preferably comprising sulfuric acid;
precipitating the mixed metal composition from the leaching solution; and
isolating the mixed metal composition from the leaching solution.

5. The method of claim 2, wherein the mixed metal composition is obtained by a method comprising
contacting electrode particles comprising
manganese, and
greater than 0 to 2 weight percent, based on the total weight of the mixed metal composition, of a compound comprising Al, Cu, Fe, Mg, Na, Ca, Zn, F, Si, Li, or a combination thereof;
with a leaching solution, preferably comprising sulfuric acid;
precipitating the mixed metal composition from the leaching solution; and
isolating the mixed metal composition from the leaching solution.

6. The method of claim 1, wherein the mixed metal composition is soluble in an aqueous solution having a pH of 5 or less.

7. The method of claim 1, wherein the mixed metal composition comprises a mixed metal sulfate, a mixed metal nitrate, a mixed metal acetate, a mixed metal hydroxide, or a combination thereof.

8. The method of claim 1, wherein the mixed metal composition comprises a mixed metal sulfate.

9. The method of claim 1, wherein the acidic solution comprises phosphoric acid and one or more of oxalic acid, acetic acid, or nitric acid.

10. The method of claim 1, wherein the mixed metal composition further comprises lithium, preferably in an amount of 100 to 1000 ppm, based on the total weight of the mixed metal composition.

11. The method of claim 1, wherein the mixed metal composition is obtained from a recycled feedstock, preferably a post-industrial recycled feedstock, a post-consumer recycled feedstock, or a combination thereof.

12. The method of claim 1, wherein the mixed metal composition comprises 0.5 to 1.5 weight percent Co, 50 to 300 ppm Cu, 50 to 200 ppm of Al, 5 to 100 ppm of Fe, or 5 to 100 ppm of F, each based on the total weight of the mixed metal composition.

13. The method of claim 1, wherein the first solution has a pH of less than 5.

14. The method of claim 1, wherein the salt of iron, manganese, cobalt, or a combination thereof is a sulfate or a hydroxide thereof.

15. The method of claim 1, wherein adding the salt of iron, manganese, cobalt, or a combination thereof to the first solution in an amount effective to provide a molar ratio of Ni:Co:Mn:Fe of greater than 0 to 0.5:greater than 0 to 0.5:greater than 0 to 1:greater than 0 to 1, preferably 0.05:0.05:0.4:0.5.

16. The method of claim 1, wherein the second solution comprises of 0.0001 to 2 weight percent, based on the total weight of the solution, of Al, Cu, Fe, Mg, Na, Ca, Zn, F, Li, or a combination thereof.

17. The method of claim 1, wherein the alkaline lithium-containing solution comprises a lithium hydroxide, lithium carbonate, lithium bicarbonate, or a combination thereof, preferably lithium hydroxide.

18. The method of claim 17, wherein the alkaline lithium-containing solution is combined with the second solution in an amount effective to provide a pH of greater than 7, preferably 7 to 10, or 7 to 9, or 7 to 8.

19. The method of claim 1, further comprising isolating the cathode active material.

20. A method of making a cathode active material, the method comprising:
contacting a mixed metal composition with water to form a first mixture, the mixed metal composition comprising
nickel, cobalt, manganese, or a combination thereof; and
greater than 0 to 2 weight percent, based on the total weight of the mixed metal composition, of a compound comprising Al, Cu, Fe, Mg, Na, Ca, Zn, F, Si, Li, or a combination thereof;
adding a salt of iron, manganese, or a combination thereof to the first mixture to provide a second mixture,
combining the second mixture and a phosphate-containing compound to provide a third mixture,
combining the third mixture with a lithium-containing compound and a carbon-containing compound to provide a cathode active material precursor, and
heat-treating the cathode active material precursor under conditions effective to provide the cathode active material,
wherein the cathode active material comprises at least one phase having an olivine structure.

21. A method of making a cathode active material, the method comprising:
contacting a mixed metal composition with water to form a first mixture, the mixed metal composition comprising
manganese, and
greater than 0 to 2 weight percent, based on the total weight of the mixed metal composition, of a compound comprising Al, Cu, Fe, Mg, Na, Ca, Zn, F, Si, Li, or a combination thereof;
adding a salt of iron, manganese, or a combination thereof to the first mixture to provide a second mixture;
combining the second mixture and a phosphate-containing compound to provide a third mixture;
combining the third mixture with a lithium-containing compound and a carbon-containing compound to provide a cathode active material precursor; and
heat-treating the cathode active material precursor under conditions effective to provide the cathode active material,
wherein the cathode active material comprises at least one phase having an olivine structure.

22. The method of claim 20, wherein the phosphate-containing compound comprises a phosphate comprising phosphoric acid, dibasic phosphate, a monobasic phosphate, or a combination thereof, preferably phosphoric acid.

23. The method of claim 20, wherein the first mixture is a slurry having a solids content of 10 weight percent or greater, based on a total weight of the slurry.

24. A cathode active material made by the method of claim 1.

25. A cathode active material comprising:
a first phase having a formula of Li₁₋ₓ M_{y}Fe_{1-y}PO₄ and having an olivine structure; and
a second phase;
wherein
M is Ni, Co, Mn, or a combination thereof;
0<x≤0.5;
0<y≤1;
0.95<(M+Fe):P<1.1;
1.0<Li:(M+Fe)<1.05;
0.95<Li:P<1.05; and
the second phase is derived from a recycled feedstock.

26. The cathode active material of claim 25, wherein the second phase comprises one or more of Al, Cu, Fe, Mg, Na, Ca, Zn, F, Si, or Li.

27. The cathode active material of claim 25, wherein the second phase derived from a recycled feedstock is present in an amount of 1 to 99 weight percent, based on the total weight of the cathode active material.

28. A cathode active material comprising:
a first phase having a formula of Li₁₋ₓM_{y}Fe_{1-y}PO₄ and having an olivine structure, wherein
M is Ni, Co, Mn, or a combination thereof;
0<x≤0.5;
0<y≤1;
0.95<(M+Fe):P<1.1;
1.0<Li:(M+Fe)<1.05;
0.95<Li:P<1.05; and
wherein the first phase further comprises Al, Cu, Fe, Mg, Na, Ca, Zn, F, Si, Li, or a combination thereof.

29. The cathode active material of claim 28, wherein the Al, Cu, Fe, Mg, Na, Ca, Zn, F, Si, Li, or a combination thereof is derived from a recycled feedstock.

30. The cathode active material of claim 25, comprising
a first cathode active material comprising the first phase; and the second phase derived from a recycled feedstock; and
a second cathode active material comprising a cathode active material derived from a virgin feedstock.

31. The cathode active material of claim 28, comprising
a first cathode active material comprising the first phase and further comprising Al, Cu, Fe, Mg, Na, Ca, Zn, F, Si, Li, or a combination thereof; and
a second cathode active material comprising a cathode active material derived from the virgin feedstock.

32. The cathode active material of claim 30, wherein the first cathode active material and the second cathode active material are combined in a weight ratio of 1:99 to 99:1.
